(19) United States
(12) Patent Application Publication
(10) Pub. No.: US 2016/0067650 A1
(43) Pub. Date: Mar. 10, 2016

(54) CARBON DIOXIDE CAPTURE SYSTEM

(71) Applicant: National Tsing Hua University, Hsinchu (TW)

(72) Inventors: Jia-Lin LIU, Hsinchu (TW); Han-Ci GAO, Hsinchu (TW); Shang-Hsiao WONG, Hsinchu (TW)

(21) Appl. No.: 14/521,769

(22) Filed: Oct. 23, 2014

(30) Foreign Application Priority Data
Sep. 4, 2014 (TW) 103130528

(51) Int. Cl. B01D 53/62; B01D 53/75; B01D 53/58

(52) U.S. Cl. CPC B01D 53/62; B01D 53/58; B01D 53/75; B01D 2258/0283

(57) ABSTRACT

A carbon dioxide capture system comprises a carbon dioxide absorption unit, an ammonia absorption unit, a carbon dioxide stripper unit, an ammonia stripper unit, a heating unit, and a condensing unit. The carbon dioxide absorption unit interconnects with the ammonia absorption unit; the carbon dioxide stripper unit interconnects with the ammonia stripper unit, whereby a first regeneration agent of the carbon dioxide stripper unit and a recirculated ammonia-rich liquid of the ammonia absorption unit directly flow into the carbon dioxide absorption unit to assist a first absorbent to absorb carbon dioxide, and whereby the heat energy generated by the heating unit is more efficiently used by the carbon dioxide absorption unit, the ammonia absorption unit, the carbon dioxide stripper unit, and the ammonia stripper unit. Compared with the conventional carbon dioxide capture system, the present invention has advantages of low power consumption and low equipment cost.

### FIELD OF THE INVENTION

The present invention relates to a gas purification system, particularly to a carbon dioxide capture system.

### BACKGROUND OF THE INVENTION

Since the industrial revolution in the nineteenth century, massive fossil fuel combustion has caused global average temperature to rise. According to the estimation by the Intergovernmental Panel on Climate Change (IPCC), carbon dioxide dominates greenhouse gases generated by human activities. The concentration of carbon dioxide has risen from 280 ppm before the industrial revolution to more than 394 ppm nowadays, which has resulted in the global warming problem.

In order to deal with the issue of global warming, the Kyoto Protocol made a clear and definite demand: all signatory countries should reduce their annual total emission of greenhouse gases by 5.2% in comparison with the emission in 1990. Therefore, reduction of carbon dioxide emission has become an important issue for all the organizations concerned.

For example, M. Zhang and Y. Guo proposed a paper “Process simulations of NH₃ abatement system for large-scale CO₂ capture using aqueous ammonia solution” in International Journal of Greenhouse Gas Control, vol. 18, pp. 114-127, 2013. The paper disclosed a carbon dioxide capture system, which comprises a carbon dioxide absorption tower, an ammonia absorption tower, a carbon dioxide stripper tower, and an ammonia stripper tower, wherein ammonia is used as an absorbent to absorb carbon dioxide in waste gases. The system has the advantage of high absorption capacity. However, each of the carbon dioxide stripper tower and the ammonia stripper tower needs a heater and a condenser, which consume considerable energy. Therefore, the conventional technology has a problem of high energy consumption.

A U.S. patent publication No. US 2013/0177489 disclosed a carbon dioxide removal system, which comprises an absorption device removing carbon dioxide from a flue gas stream and a regeneration device interconnecting with the absorption device. The regeneration device separates carbon dioxide from an ion solution and supplies the regenerated ion solution to the absorption device. The carbon dioxide removal system also comprises a carbon dioxide water wash system interconnecting with the regeneration device, receiving the mixture of carbon dioxide and ammonia from the regeneration device, and separating ammonia from carbon dioxide. The carbon dioxide removal system also comprises an ammonia water wash system interconnecting with the absorption device and the carbon dioxide water wash system and removing ammonia from the flue gas stream. The carbon dioxide removal system also comprises a membrane separator interconnecting with the ammonia water wash system and one or both of the regeneration device and the carbon dioxide water wash system. The membrane separator can reduce the power consumption of the carbon dioxide removal system.

Although the membrane separator can reduce power consumption, it increases the equipment cost. Therefore, the conventional technology still has room to improve.

### SUMMARY OF THE INVENTION

The primary objective of the present invention is to solve the problem that the conventional carbon dioxide capture system needs a heater and a condenser, which are respectively installed in an ammonia stripper tower and a carbon dioxide stripper tower and consume much power, or the problem that the conventional carbon dioxide capture system alternatively needs a membrane separator, which can reduce power consumption but increases equipment cost.

To achieve the abovementioned objectives, the present invention proposes a carbon dioxide capture system, which comprises a carbon dioxide absorption unit, an ammonia absorption unit, a carbon dioxide stripper unit, an ammonia stripper unit, and a heating unit. The carbon dioxide absorption unit receives a flue gas stream, has a first absorbent and includes a first bottom section and a first top section. The ammonia absorption unit interconnects with the carbon dioxide absorption unit, has a second absorbent and includes a second bottom section and a second top section. The flue gas stream is input into the carbon dioxide absorption unit to react with the first absorbent. Thus, the first top section of the carbon dioxide absorption unit outputs a carbon dioxide-lean gas stream, and the first bottom section outputs a carbon dioxide-rich fluid. The carbon dioxide-lean gas stream is input into the ammonia absorption unit to react with the second absorbent. Thus, the second top section of the ammonia absorption unit outputs a purified gas. Further, the second bottom section outputs a recirculated ammonia-rich liquid to the carbon dioxide absorption unit.

The carbon dioxide stripper unit interconnects with the carbon dioxide absorption unit and the ammonia absorption unit and includes a third bottom section and a third top section. The ammonia stripper unit interconnects with the carbon dioxide stripper unit and the ammonia absorption unit and includes a fourth bottom section and a fourth top section. The carbon dioxide stripper unit receives the carbon dioxide-rich fluid and undertakes an evaporation-separation process to generate a carbon dioxide gas stream, which is output from the third top section and a first regeneration agent flowing to the carbon dioxide absorption unit and the ammonia stripper unit.

The heating unit is connected with the fourth bottom section. The first regeneration agent is evaporated and separated by the heating unit in the ammonia stripper unit to generate an ammonia-rich gas stream output from the fourth top section to the carbon dioxide stripper unit and a second regeneration agent output to the ammonia absorption unit.

In the present invention, the carbon dioxide absorption unit interconnects with the ammonia absorption unit, and the carbon dioxide stripper unit interconnects with an ammonia stripper unit. Thereby, the first regeneration agent directly flows to the ammonia stripper unit and the carbon dioxide absorption unit; the recirculated ammonia-rich liquid directly flows to the carbon dioxide absorption unit; the heat generated by the heating unit can be more efficiently used by the carbon dioxide absorption unit, the ammonia absorption unit, the carbon dioxide stripper unit, and the ammonia stripper unit. In comparison with the conventional carbon dioxide capture system, the present invention uses fewer heating units and fewer condensers and does not need a membrane separator. Therefore, the present invention has advantages of low power consumption and low equipment cost.

### BRIEF DESCRIPTION OF THE DRAWINGS

FIG. 1 is a diagram schematically showing a carbon dioxide capture system according to one embodiment of the present invention;

FIG. 2A is a diagram comparing the power consumptions of the present invention and the prior art using 3 wt % ammonia absorbent;

FIG. 2B is another diagram comparing the power consumptions of the present invention and the prior art using 7 wt % ammonia absorbent; and

FIG. 2C is a further diagram comparing the power consumptions of the present invention and the prior art using 9 wt % ammonia absorbent.

### DETAILED DESCRIPTION OF THE PREFERRED EMBODIMENTS

The technical contents of the present invention will be described in detail in cooperation with drawings below.

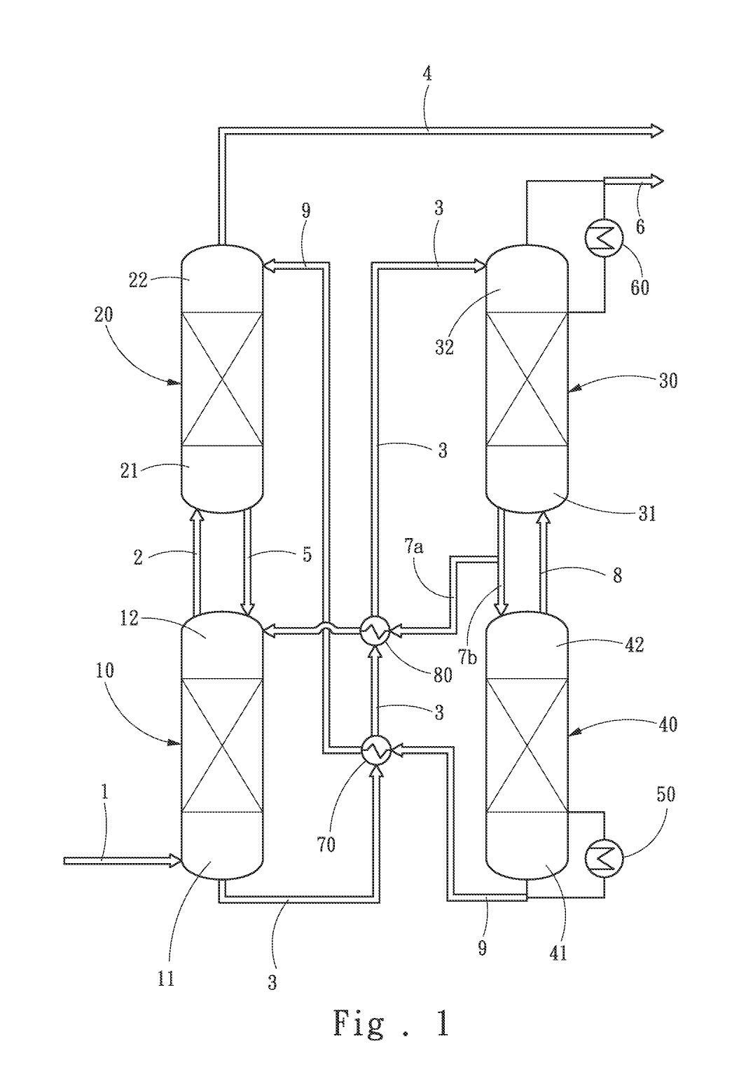

Refer to FIG. 1 a diagram schematically showing a carbon dioxide capture system according to one embodiment of the present invention. The carbon dioxide capture system of the present invention comprises a carbon dioxide absorption unit 10, an ammonia absorption unit 20, a carbon dioxide stripper unit 30, an ammonia stripper unit 40, a heating unit 50, and a condensing unit 60. The carbon dioxide absorption unit 10 receives a flue gas stream 1, which may be a blast furnace gas (BFG) containing carbon dioxide. The carbon dioxide absorption unit 10 has a first absorbent including 3-9 wt % ammonia and used to react with carbon dioxide. The carbon dioxide absorption unit 10 includes a first bottom section 11, a first top section 12 and a plurality of filling materials arranged between the first bottom section 11 and the first top section 12. In one embodiment, the filling materials are Raschig rings or Pall rings.

The ammonia absorption unit 20 interconnects with the carbon dioxide absorption unit 10. The ammonia absorption unit 20 has a second absorbent including 0.1 g/l ammonia and 0.02 g/l carbon dioxide and used to react with ammonia. In one embodiment, the second absorbent is an acidic recirculated liquid. The ammonia absorption unit 20 includes a second bottom section 21, a second top section 22, and a plurality of filling materials arranged between the second bottom section 21 and the second top section 22.

The carbon dioxide stripper unit 30 interconnects with the carbon dioxide absorption unit 10 and includes a third bottom section 31 and a third top section 32. The third top section 32 is connected with the condensing unit 60. In one embodiment, the condensing unit 60 is a condenser.

The ammonia stripper unit 40 interconnects with the carbon dioxide stripper unit 30 and the ammonia absorption unit 20 and includes a fourth bottom section 41 and a fourth top section 42. The fourth bottom section 41 is connected with the heating unit 50. In one embodiment, the heating unit 50 is a heater.

In the embodiment shown in FIG. 1, the carbon dioxide capture system further comprises a first heat exchanger 70 and a second heat exchanger 80. The first heat exchanger 70 is arranged between the ammonia absorption unit 20 and the ammonia stripper unit 40 and interconnects with the ammonia absorption unit 20 and the ammonia stripper unit 40. The first heat exchanger 70 is also arranged between the carbon dioxide absorption unit 10 and the carbon dioxide stripper unit 30 and interconnects with the carbon dioxide absorption unit 10 and the carbon dioxide stripper unit 30. The second heat exchanger 80 is arranged between the first heat exchanger 70 and the carbon dioxide stripper unit 30 and interconnects with the first heat exchanger 70 and the carbon dioxide stripper unit 30. The second heat exchanger 80 is also arranged between the carbon dioxide stripper unit 30 and the carbon dioxide absorption unit 10 and interconnects with the carbon dioxide stripper unit 30 and the carbon dioxide absorption unit 10.

In the embodiment shown in FIG. 1, the flue gas stream 1 is exemplified by a gas stream including 26.8 vol % carbon dioxide. At an atmospheric pressure of 1 atm and a temperature of 25° C., the flue gas stream 1 is input from the first bottom section 11 to the carbon dioxide absorption unit 10 at a flow rate of 87 m³/h. The plentiful filling materials of the carbon dioxide absorption unit 10 increase the reaction area between the first absorbent and the flue gas stream 1. The first absorbent reacts with the carbon dioxide of the flue gas stream 1 to generate a carbon dioxide-lean gas stream 2 outputs from the first top section 12 and a carbon dioxide-rich fluid 3 outputs from the first bottom section 11.

In the embodiment shown in FIG. 1, the carbon dioxide-lean gas stream 2 may have 2.7 wt % ammonia. The carbon dioxide-lean gas stream 2 is input into the ammonia absorption unit 20 via the second bottom section 21 to react with the second absorbent. Similarly, the filling materials of the ammonia absorption unit 20 increase the reaction area. The carbon dioxide-lean gas stream 2 reacts with the second absorbent to generate a purified gas 4, which outputs from the second top section 22, and a recirculated ammonia-rich liquid 5 that outputs from the second bottom section 21 to the carbon dioxide absorption unit 10. The purified gas 4 has a very low concentration of ammonia, such as 44 ppm ammonia, and meets the environmental regulation. The recirculated ammonia-rich liquid 5 is input into the carbon dioxide absorption unit 10 via the first top section 12, assisting the first absorbent to absorb carbon dioxide.

The carbon dioxide-rich fluid 3 is output from the bottom section 11 to the carbon dioxide stripper unit 30. During the process of outputting the carbon dioxide-rich fluid 3 from the bottom section 11 to the carbon dioxide stripper unit 30, the carbon dioxide-rich fluid 3 passes through the first heat exchanger 70 and the second heat exchanger 80 and is heated by the first heat exchanger 70 and the second heat exchanger 80. After the carbon dioxide-rich fluid 3 enters the carbon dioxide stripper unit 30 via the third top section 32, the carbon dioxide-rich fluid 3 is evaporated at a low pressure, and the vapor thereof is condensed by the condensing unit 60 to generate a carbon dioxide gas stream 6 output from the third top section 32 and first regeneration agents 7a and 7b output from the third bottom section 31 and respectively flowing to the carbon dioxide absorption unit 10 and the ammonia stripper unit 40. At this time, the carbon dioxide gas stream 6 has a high concentration (e.g. 98.8 wt %) of carbon dioxide and a low concentration (e.g. 50 ppm) of ammonia.

After the first regeneration agents 7a and 7b are output from the third bottom section 31, the first regeneration agents 7a is to be transported to the carbon dioxide absorption unit 10. Before the first regeneration agent 7a is transported to the carbon dioxide absorption unit 10, the heat energy of the first regeneration agents 7a is transferred to the second heat exchanger 80. The second exchanger 80 supplies the heat energy to the carbon dioxide-rich fluid 3 passing through the second heat exchanger 80. Thus, the temperature of the first regeneration agent 7a is decreased. Then, the first regeneration agent 7a is input into the carbon dioxide absorption unit 10 via the first top section 12, assisting the first absorbent to absorb carbon dioxide. The first regeneration agent 7b is input into the ammonia stripper unit 40 via the fourth top section 42. The first regeneration agent 7b is heated by the heating unit 50 at the fourth bottom section 41, evaporated and separated to generate an ammonia-rich gas stream 8, which flows from the fourth top section 42 through the third bottom section 31 to the carbon dioxide stripper unit 30. Further, a second regeneration agent 9 is also generated in the abovementioned evaporation and separation process and flows to the ammonia absorption unit 20. At this time, the ammonia-rich gas stream 8 may include 19.5 wt % ammonia, 15.2 wt % carbon dioxide and 65.3 wt % water vapor and have a temperature of 91.3° C. and a flow rate of 68.8 kg/h. The second regeneration agent 9 flows out of the fourth bottom section 41, passes through the first heat exchanger 70, and transfers heat energy to the first heat exchanger 70. The first heat exchanger 70 supplies the heat energy to the carbon dioxide-rich fluid 3 passing through the first heat exchanger 70. Thus, the temperature of the second regeneration agent 9 is decreased. Then, the second regeneration agent 9 is input into the ammonia absorption unit 20 via the second top section 22, assisting the second absorbent to absorb ammonia. In one embodiment, the second regeneration agent 9 includes 0.1 g/l ammonia and 0.02 g/l carbon dioxide and has a temperature of 15° C.

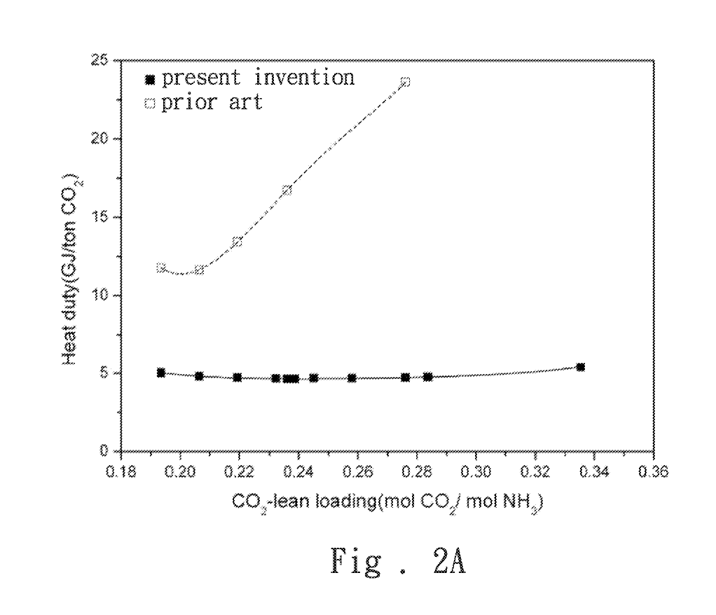

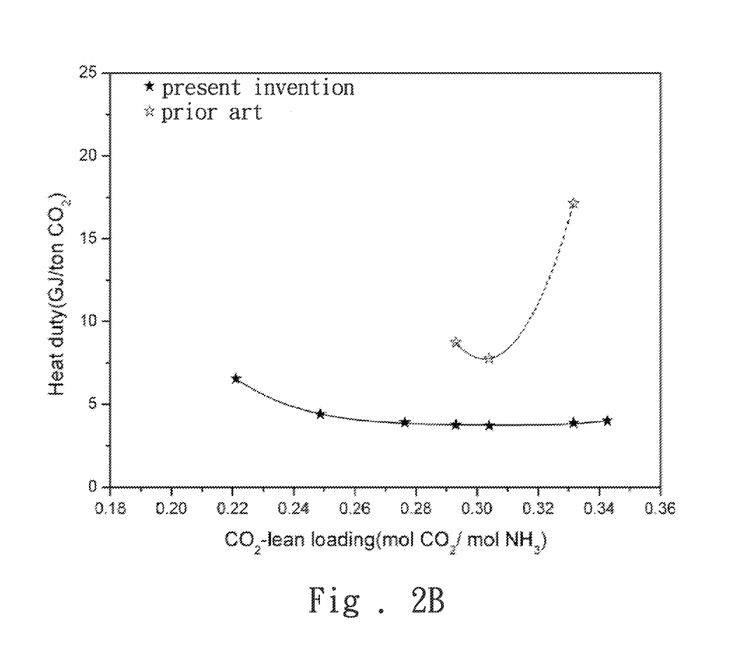

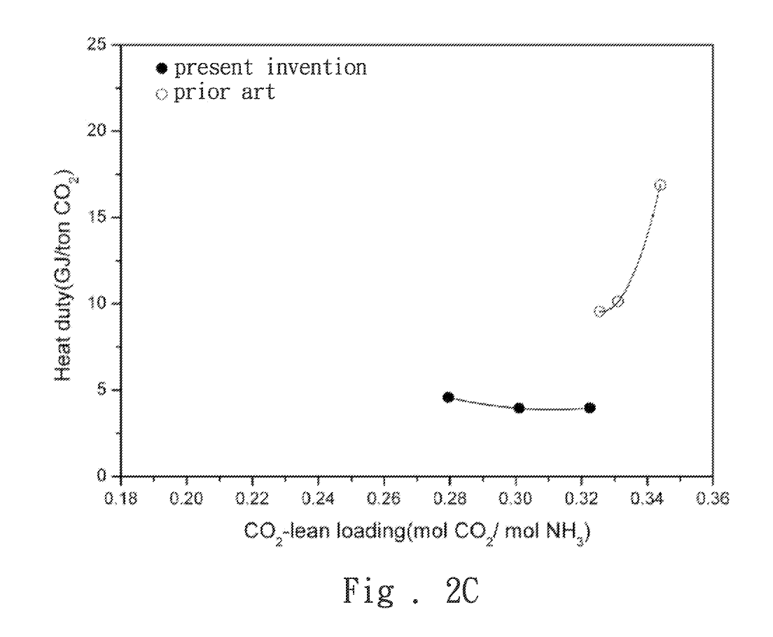

Refer to FIGS. 2A-2C diagrams showing the energy consumptions of the carbon dioxide capture system of the present invention and the conventional carbon dioxide capture system while the ammonia concentrations of the first absorbent (the carbon dioxide absorbent for the conventional carbon dioxide capture system) are respectively 3 wt %, 7 wt % and 9 wt %. From FIGS. 2A-2C, it is learned: the carbon dioxide capture system of the present invention saves more than ⅓ of the energy consumed by the conventional carbon dioxide capture system. For example, in FIG. 2B, while the ammonia concentration is 7 wt % and the CO₂-lean loading is 0.3 (mol/mol), the heat duty of the carbon dioxide capture system of the present invention is about 3.72 GJ/ton-CO₂, and the heat duty of the conventional carbon dioxide capture system is about 7.77 GJ/ton-CO₂. Therefore, the carbon dioxide capture system of the present invention not only can reduce the equipment cost of the heating unit 50 and the condensing unit 60 but also can greatly reduce the energy consumption of the system. Hence, the present invention has higher potential in the market.

In the present invention, the carbon dioxide absorption unit interconnects with the ammonia absorption unit, and the carbon dioxide stripper unit interconnects with ammonia stripper unit. Thereby, the first regeneration agent and the recirculated ammonia-rich liquid can directly flow into the carbon dioxide absorption unit, assisting the first absorbent to absorb carbon dioxide. Further, the heat energy generated by the heating unit can be more efficiently used by the carbon dioxide absorption unit, the ammonia absorption unit, the carbon dioxide stripper unit and the ammonia stripper unit. In comparison with the conventional carbon dioxide capture system, the present invention uses fewer heating units and fewer condensers and does not need a membrane separator. Therefore, the present invention has advantages of low power consumption and low equipment cost. Hence, the present invention possesses utility, novelty and non-obviousness and meets the condition for a patent. Thus, the Inventors file the application for a patent. It is appreciated if the patent is approved fast.

The present invention has been demonstrated in detail with the embodiments described above. However, these embodiments are only to exemplify the present invention but not to limit the scope of the present invention. Any equivalent modification or variation according to the spirit of the present invention is to be also included within the scope of the present invention.

What is claimed is:

1. A carbon dioxide capture system comprising:
a carbon dioxide absorption unit receiving a flue gas stream, having a first absorbent, and including a first bottom section and a first top section;
an ammonia absorption unit interconnecting with the carbon dioxide absorption unit, having a second absorbent, and including a second bottom section and a second top section, wherein the flue gas stream is input into the carbon dioxide absorption unit to react with the first absorbent and generate a carbon dioxide-lean gas stream output from the first top section and a carbon dioxide-rich fluid output from the first bottom section, and wherein the carbon dioxide-lean gas stream is input into the ammonia absorption unit to react with the second absorbent and generate a purified gas output from the second top section and a recirculated ammonia-rich liquid output from the second bottom section to the carbon dioxide absorption unit;
a carbon dioxide stripper unit interconnecting with the carbon dioxide absorption unit and includes a third bottom section and a third top section;
an ammonia stripper unit interconnecting with the carbon dioxide stripper unit and the ammonia absorption unit and including a fourth bottom section and a fourth top section, wherein the carbon dioxide-rich fluid is input into the carbon dioxide stripper unit for evaporation and separation to generate a carbon dioxide gas stream output from the third top section and first regeneration agents respectively flowing to the carbon dioxide absorption unit and the ammonia stripper unit; and
a heating unit connected with the fourth bottom section, wherein the first regeneration agent is evaporated and separated by the heating unit in the ammonia stripper unit to generate an ammonia-rich gas stream flowing from the fourth top section to the carbon dioxide stripper unit, and a second regeneration agent flowing to the ammonia absorption unit.

2. The carbon dioxide capture system according to claim 1 further comprising a condensing unit connected with the third top section and condensing the carbon dioxide-rich fluid to separate the carbon dioxide gas stream from the carbon dioxide-rich fluid.

3. The carbon dioxide capture system according to claim 1, wherein the first absorbent includes 3-9 wt % ammonia.

4. The carbon dioxide capture system according to claim 1, wherein the second absorbent includes a recirculated acidic liquid.

5. The carbon dioxide capture system according to claim 1 further comprising a first heat exchanger interconnecting with the ammonia absorption unit and the ammonia stripper unit and undertaking heat exchange with the second regeneration agent.

6. The carbon dioxide capture system according to claim 5, wherein the first heat exchanger also interconnects with the carbon dioxide absorption unit and the carbon dioxide stripper unit and undertakes heat exchange with the carbon dioxide-rich fluid.

7. The carbon dioxide capture system according to claim 6 further comprising a second heat exchanger interconnects with the first heat exchanger and the carbon dioxide stripper unit and undertakes heat exchange with the carbon dioxide-rich fluid.

8. The carbon dioxide capture system according to claim 7, wherein the second heat exchanger also interconnects with the carbon dioxide stripper unit and the carbon dioxide absorption unit and undertakes heat exchange with the first regeneration agent.
